(19) United States
(12) Patent Application Publication
(10) Pub. No.: US 2016/0165895 A1
(43) Pub. Date: Jun. 16, 2016

(54) APPLICATION OF MIXOTROPHIC CHLORELLA FOR THE ACCELERATED EMERGENCE AND MATURATION OF FABACEAE PLANTS

(71) Applicant: Heliae Development, LLC, Gilbert, AZ (US)

(72) Inventors: Sandip SHINDE, Gilbert, AZ (US); Nicholas DONOWITZ, Shelburne, VT (US); Michael Clint ROHLFSEN, Edina, MN (US)

(21) Appl. No.: 14/602,348

(22) Filed: Jan. 22, 2015

Related U.S. Application Data
(60) Provisional application No. 62/092,771, filed on Dec. 16, 2014.

(51) Int. Cl. A01N 63/00

(52) U.S. Cl. CPC A01N 63/00

(57) ABSTRACT

Methods of accelerating emergence and maturation of plants in the Fabaceae family by administering an effective amount of a mixotrophic Chlorella based liquid composition in low concentration applications are disclosed. The administration may comprise seed soak and soil applications of the composition.

### CROSS REFERENCE TO RELATED APPLICATIONS

This application claims the benefit of U.S. Provisional Application No. 62/092,771, filed Dec. 16, 2014, entitled Application of Mixotrophic Chlorella for the Accelerated Emergence and Maturation of Fabaceae Plants, the entire contents of which are hereby incorporated by reference herein.

### BACKGROUND

Seed emergence occurs as an immature plant breaks out of its seed coat, typically followed by the rising of a stem out of the soil. The first leaves that appear on many seedlings are the so-called seed leaves, or cotyledons, which often bear little resemblance to the later leaves. Shortly after the first true leaves, which are more or less typical of the plant, appear, the cotyledons will drop off. Germination of seeds is a complex physiological process triggered by imbibition of water after possible dormancy mechanisms have been released by appropriate triggers. Under favorable conditions rapid expansion growth of the embryo culminates in rupture of the covering layers and emergence of the radicle. A number of agents have been proposed as modulators of seed emergence. Temperature and moisture modulation are common methods of affecting seed emergence. Addition of nutrients to the soil has also been proposed to promote emergence of seeds of certain plants. The effectiveness may be attributable to the ingredients or the method of preparing the product. Increasing the effectiveness of a product may reduce the amount of the product needed and increase efficiency of the agricultural process.

### SUMMARY

In one non-limiting embodiment, a method for enhancing emergence of a Fabaceae plant from seed may comprise: administering a liquid composition treatment comprising a Chlorella culture in which the microalgae cell content of the culture consists essentially of whole pasteurized Chlorella cells in a concentration in the range of 0.003-0.080% solids by weight to a planted seed of a Fabaceae plant in an amount effective to enhance emergence of seeds, maturation, or both in a population of such seeds compared to seeds in a substantially identical population of untreated seeds.

In some embodiments, the administration may comprise soaking the seed in an effective amount of the liquid composition before planting the seed. In some embodiments, the seed may be soaked for a time period in the range of 90-150 minutes. In some embodiments, the liquid composition may comprise a concentration in the range of 0.008-0.080% solids by weight of whole pasteurized Chlorella cells. In some embodiments, the method may further comprise removing the seed from the liquid composition and drying the seed before planting the seed.

In some embodiments, the administration may comprise contacting the soil in the immediate vicinity of the planted seed with an effective amount of the liquid composition. In some embodiments, the liquid composition may comprise a concentration in the range of 0.004-0.080% solids by weight of whole pasteurized Chlorella cells. In some embodiments, the liquid composition may be administered at a rate in the range of 50-150 gallons per acre.

In some embodiments, the Fabaceae plant may comprise a green bean plant. In some embodiments, the liquid composition may further comprise a stabilizing means suitable for plants. In some embodiments, the whole Chlorella cells may not be subjected to a drying process. In some embodiments, the Chlorella cells may be cultured in mixotrophic conditions. In some embodiments, the Chlorella cells may be cultured in non-axenic mixotrophic conditions. In some embodiments, the liquid composition may not contain an active ingredient for enhancing emergence or maturation other than the culture of whole Chlorella cells.

In some embodiments, the number of plants emerged from the soil may be increased by at least 20% compared to a substantially identical population of untreated seeds of plants. In some embodiments, the number of plants demonstrating maturation by leaf formation may be increased by at least 30% compared to a substantially identical population of untreated seeds of plants.

In another non-limiting embodiment, a method of enhancing emergence of a Fabaceae plant from seed may comprise: providing a liquid composition treatment comprising a Chlorella culture in which the microalgae cell content of the culture consists essentially of whole pasteurized Chlorella cells in a concentration in the range of 5-30% solids by weight; diluting the liquid composition with water to a concentration in the range of 0.003-0.080% solids by weight of whole pasteurized Chlorella cells; and administering the liquid composition treatment to a planted seed of a Fabaceae plant in an amount effective to enhance emergence of seeds, maturation, or both in a population of such seeds compared to seeds in a substantially identical population of untreated seeds.

### DETAILED DESCRIPTION

The Fabaceae plant family (also known as the Leguminosae) comprises the third largest plant family with over 18,000 species, including a number of important agricultural and food plants. Taxonomically classified in the Plantae kingdom, Tracheobionta (subkingdom), Spermatophyta (superdivision), Magnoliophyta (division), Manoliopsida (class), Rosidae (subclass), and Fabales (order), the Fabaceae family includes, but is not limited to, soybeans, beans, green beans, peas, chickpeas, alfalfa, peanuts, sweet peas, carob, and liquorice. Plants in the Fabaceae family may range in size and type, including but not limited to, trees, small annual herbs, shrubs, and vines, and typically develop legumes. Plants in the Fabaceae family can be found on all the continents, excluding Antarctica, and thus have a widespread importance in agriculture across the globe. Besides food, plants in the Fabaceae family may be used to produce natural gums, dyes, and ornamentals.

Particularly important in the production of Fabaceae plants is the beginning stage of growth where the plant emerges and matures into establishment. A method of treating a seed, seedling, or plant to directly improve the germination, emergence, and maturation of the plant; or to indirectly enhance the microbial soil community surrounding the seed or seedling is therefore valuable in starting the plant on the path to marketable production. The standard used for assessing emergence is the achievement of the hypocotyl stage, where a stem is visibly protruding from the soil. The standard used for assessing maturation is the achievement of the cotyledon stage, where two leaves visibly form on the emerged stem.

To achieve such improvements in emergence and maturation of Fabaceae plants, the inventors developed a method to treat such seeds with a low concentration liquid microalgae based composition. The microalgae of the liquid composition comprise Chlorella sp. cultured in mixotrophic conditions, which comprises a culture medium primary comprised of water with trace nutrients (e.g., nitrates, phosphates, vitamins, metals found in BG-11 recipe (available from UTEX The Culture Collection of Algae at the University of Texas at Austin, Austin, Tex.)), light as an energy source for photosynthesis, organic carbon (e.g., acetate, acetic acid) as both an energy source and a source of carbon. In some embodiments, the culture media may comprise BG-11 media or a media derived from BG-11 culture media (e.g., in which additional component(s) are added to the media and/or one or more elements of the media is increased by 5%, 10%, 15%, 20%, 25%, 33%, 50%, or more over unmodified BG-11 media). In some embodiments, the Chlorella may be cultured in non-axenic mixotrophic conditions in the presence of contaminating organisms, such as but not limited to bacteria. Methods of culturing such microalgae in non-axenic mixotrophic conditions may be found in W02014/074769A2 (Ganuza, et al.), hereby incorporated by reference.

By artificially controlling aspects of the Chlorella culturing process such as the organic carbon feed (e.g., acetic acid, acetate), oxygen levels, pH, and light, the culturing process differs from the culturing process that Chlorella experiences in nature. In addition to controlling various aspects of the culturing process, intervention by human operators or automated systems occurs during the non-axenic mixotrophic culturing of Chlorella through contamination control methods to prevent the Chlorella from being overrun and outcompeted by contaminating organisms (e.g., fungi, bacteria). Contamination control methods for microalgae cultures are known in the art and such suitable contamination control methods for non-axenic mixotrophic microalgae cultures are disclosed in W02014/074769A2 (Ganuza, et al.), hereby incorporated by reference. By intervening in the microalgae culturing process, the impact of the contaminating microorganisms can be mitigated by suppressing the proliferation of containing organism populations and the effect on the microalgal cells (e.g., lysing, infection, death, clumping). Thus through artificial control of aspects of the culturing process and intervening in the culturing process with contamination control methods, the Chlorella culture produced as a whole and used in the described inventive compositions differs from the culture that results from a Chlorella culturing process that occurs in nature.

During the mixotrophic culturing process the Chlorella culture may also comprise cell debris and compounds excreted from the Chlorella cells into the culture medium. The output of the Chlorella mixotrophic culturing process provides the active ingredient for composition that is applied to plants for improving yield and quality without separate addition to or supplementation of the composition with other active ingredients not found in the mixotrophic Chlorella whole cells and accompanying culture medium from the mixotrophic culturing process such as, but not limited to: non-Chlorella microalgae cells, microalgae extracts, macroalgae, macroalgae extracts, liquid fertilizers, granular fertilizers, mineral complexes (e.g., calcium, sodium, zinc, manganese, cobalt, silicon), fungi, bacteria, nematodes, protozoa, digestate solids, chemicals (e.g., ethanolamine, borax, boric acid), humic acid, nitrogen and nitrogen derivatives, phosphorus rock, pesticides, herbicides, insecticides, enzymes, plant fiber (e.g., coconut fiber).

Mixotrophic Chlorella is the dominate microalgae species in the liquid composition. In some embodiments, the microalgae population of the liquid composition is substantially mixotrophic Chlorella. In some embodiments, mixotrophic or non-mixotrophic Chlorella comprises at least 90% of the microalgae population of the liquid composition. In some embodiments, mixotrophic or non-mixotrophic Chlorella comprises at least 91% of the microalgae population of the liquid composition. In some embodiments, mixotrophic or non-mixotrophic Chlorella comprises at least 92% of the microalgae population of the liquid composition. In some embodiments, mixotrophic or non-mixotrophic Chlorella comprises at least 93% of the microalgae population of the liquid composition. In some embodiments, mixotrophic or non-mixotrophic Chlorella comprises at least 94% of the microalgae population of the liquid composition. In some embodiments, mixotrophic or non-mixotrophic Chlorella comprises at least 95% of the microalgae population of the liquid composition. In some embodiments, mixotrophic or non-mixotrophic Chlorella comprises at least 96% of the microalgae population of the liquid composition. In some embodiments, mixotrophic or non-mixotrophic Chlorella comprises at least 97% of the microalgae population of the liquid composition. In some embodiments, mixotrophic or non-mixotrophic Chlorella comprises at least 98% of the microalgae population of the liquid composition. In some embodiments, mixotrophic or non-mixotrophic Chlorella comprises at least 99% of the microalgae population of the liquid composition. Liquid compositions having at least 99% of a Chlorella microalgae strain (e.g., at least 99.3%, at least 99.5%, or even at least 99.9%), such as mixotrophic Chlorella, can be considered to have a single algal species in the liquid composition. In one aspect, the liquid composition lacks any detectable amount of any other microalgae species. In another aspect, the liquid composition lacks any amount of any other microorganism in the liquid composition other than the desired Chlorella microalgae (e.g., bacteria) that is above 1% of the composition by weight).

While separate active ingredients are not added to or supplemented in the mixotrophic Chlorella based composition, the liquid composition comprising the mixotrophic Chlorella whole cells and accompanying constituents from the culturing medium and process (e.g., trace nutrients, residual organic carbon, bacteria, cell debris, cell excretions) may be stabilized by heating and cooling in a pasteurization process. As shown in the Examples, the inventors found that the active ingredients of the mixotrophic Chlorella based composition maintained effectiveness in improving plant germination, emergence, and maturation when applied to Fabaceae plants after being subjected to the heating and cooling of a pasteurization process.

In some embodiments, the composition may be heated to a temperature in the range of 50-70° C. In some embodiments, the composition may be heated to a temperature in the range of 55-65° C. In some embodiments, the composition may be heated to a temperature in the range of 58-62° C. In some embodiments, the composition may be heated to a temperature in the range of 50-60° C. In some embodiments, the composition may be heated to a temperature in the range of 60-70° C.

In some embodiments, the composition may be heated for a time period in the range of 90-150 minutes. In some embodiments, the composition may be heated for a time period in the range of 110-130 minutes. In some embodiments, the composition may be heated for a time period in the range of 90-100 minutes. In some embodiments, the composition may be heated for a time period in the range of 100-110 minutes. In some embodiments, the composition may be heated for a time period in the range of 110-120 minutes. In some embodiments, the composition may be heated for a time period in the range of 120-130 minutes. In some embodiments, the composition may be heated for a time period in the range of 130-140 minutes. In some embodiments, the composition may be heated for a time period in the range of 140-150 minutes.

In some embodiments, the composition may be cooled to a temperature in the range of 35-45° C. In some embodiments, the composition may be cooled to a temperature in the range of 36-44° C. In some embodiments, the composition may be cooled to a temperature in the range of 37-43° C. In some embodiments, the composition may be cooled to a temperature in the range of 38-42° C. In some embodiments, the composition may be cooled to a temperature in the range of 39-41° C.

In some embodiments, the mixotrophic Chlorella may be previously frozen and thawed before inclusion in the liquid composition. In some embodiments, the mixotrophic Chlorella may not have been subjected to a previous freezing or thawing process. In some embodiments, the mixotrophic Chlorella whole cells have not been subjected to a drying process. The cell walls of the mixotrophic Chlorella of the composition have not been lysed or disrupted, and the mixotrophic Chlorella cells have not been subjected to an extraction process or process that pulverizes the cells. The mixotrophic Chlorella whole cells are not subjected to a purification process for isolating the mixotrophic Chlorella whole cells from the accompanying constituents of the culturing process (e.g., trace nutrients, residual organic carbon, bacteria, cell debris, cell excretions), and thus the whole output from the mixotrophic Chlorella culturing process comprising whole Chlorella cells, culture medium, cell excretions, cell debris, bacteria, residual organic carbon, and trace nutrients, is used in the liquid composition for application to plants. In some embodiments, the mixotrophic Chlorella whole cells and the accompanying constituents of the culturing process are concentrated in the composition. In some embodiments, the mixotrophic Chlorella whole cells and the accompanying constituents of the culturing process are diluted in the composition to a low concentration. The mixotrophic Chlorella whole cells of the composition are not fossilized. In some embodiments, the mixotrophic Chlorella whole cells are not maintained in a viable state in the composition for continued growth after the method of using the composition in a soil or foliar application. In some embodiments, the mixotrophic Chlorella base composition may be biologically inactive after the composition is prepared. In some embodiments, the mixotrophic Chlorella base composition may be substantially biologically inactive after the composition is prepared. In some embodiments, the mixotrophic Chlorella base composition may increase in biological activity after the prepared composition is exposed to air.

In some embodiments, the composition may comprise 5-30% solids by weight of whole mixotrophic Chlorella cells. In some embodiments, the composition may comprise 5-20% solids by weight of whole mixotrophic Chlorella cells. In some embodiments, the composition may comprise 5-15% solids by weight of whole mixotrophic Chlorella cells. In some embodiments, the composition may comprise 5-10% solids by weight of whole mixotrophic Chlorella cells. In some embodiments, the composition may comprise 10-20% solids by weight of whole mixotrophic Chlorella cells. In some embodiments, the composition may comprise 10-20% solids by weight of whole mixotrophic Chlorella cells. In some embodiments, the composition may comprise 20-30% solids by weight of whole mixotrophic Chlorella cells. In some embodiments, further dilution of the whole mixotrophic Chlorella cells percent solids by weight may be occur before application for low concentration applications of the composition.

In some embodiments, the composition may comprise less than 1% solids by weight of whole mixotrophic Chlorella cells. In some embodiments, the composition may comprise less than 0.9% solids by weight of whole mixotrophic Chlorella cells. In some embodiments, the composition may comprise less than 0.8% solids by weight of whole mixotrophic Chlorella cells. In some embodiments, the composition may comprise less than 0.7% solids by weight of whole mixotrophic Chlorella cells. In some embodiments, the composition may comprise less than 0.6% solids by weight of whole mixotrophic Chlorella cells. In some embodiments, the composition may comprise less than 0.5% solids by weight of whole mixotrophic Chlorella cells. In some embodiments, the composition may comprise less than 0.4% solids by weight of whole mixotrophic Chlorella cells. In some embodiments, the composition may comprise less than 0.3% solids by weight of whole mixotrophic Chlorella cells. In some embodiments, the composition may comprise less than 0.2% solids by weight of whole mixotrophic Chlorella cells. In some embodiments, the composition may comprise less than 0.1% solids by weight of whole mixotrophic Chlorella cells. In some embodiments, the effective amount in an application of the liquid composition for enhanced germination, emergence, or maturation may comprise a concentration of solids of mixotrophic Chlorella whole cells in the range of 0.002642-0.079252% (e.g., about 0.003% to about 0.080%), equivalent to a diluted concentration of 2-10 mL/gallon of a solution with an original percent solids of mixotrophic Chlorella whole cells in the range of 5-30%.

In some embodiments, the liquid composition may comprise low concentrations of bacteria contributing to the solids percentage of the composition in addition to the whole mixotrophic Chlorella cells. Examples of bacteria found in non-axenic mixotrophic conditions may be found in W02014/074769A2 (Ganuza, et al.), hereby incorporated by reference. A live bacteria count may be determined using methods known in the art such as plate counts, plates counts using Petrifilm available from 3M (St. Paul, Minn.), spectrophotometric (turbidimetric) measurements, visual comparison of turbidity with a known standard, direct cell counts under a microscope, cell mass determination, and measurement of cellular activity. Live bacteria counts in a non-axenic mixotrophic microalgae culture may range from 10⁴ to 10⁹ CFU/mL, and may depend on contamination control measures taken during the culturing of the microalgae. The level of bacteria in the composition may be determined by an aerobic plate count which quantifies aerobic colony forming units (CFU) in a designated volume. In some embodiments, the composition comprises an aerobic plate count of 40,000-400,000 CFU/mL. In some embodiments, the composition comprises an aerobic plate count of 40,000-100,000 CFU/mL. In some embodiments, the composition comprises an aerobic plate count of 100,000-200,000 CFU/mL. In some embodiments, the composition comprises an aerobic plate count of 200,000-300,000 CFU/mL. In some embodiments, the composition comprises an aerobic plate count of 300,000-400,000 CFU/mL.

In some embodiments, stabilizing means that are not active regarding the improvement of plant germination, emergence, and maturation, but instead aid in stabilizing the composition may be added to prevent the proliferation of unwanted microorganisms (e.g., yeast, mold) and prolong shelf life. Such inactive but stabilizing means may comprise an acid, such as but not limited to phosphoric acid, and a yeast and mold inhibitor, such as but not limited to potassium sorbate. In some embodiments, the stabilizing means are suitable for plants and do not inhibit the growth or health of the plant. In the alternative, the stabilizing means may contribute to nutritional properties of the liquid composition, such as but not limited to, the levels of nitrogen, phosphorus, or potassium.

In some embodiments, the composition may comprise less than 0.3% phosphoric acid. In some embodiments, the composition may comprise 0.01-0.3% phosphoric acid. In some embodiments, the composition may comprise 0.05-0.25% phosphoric acid. In some embodiments, the composition may comprise 0.01-0.1% phosphoric acid. In some embodiments, the composition may comprise 0.1-0.2% phosphoric acid. In some embodiments, the composition may comprise 0.2-0.3% phosphoric acid.

In some embodiments, the composition may comprise less than 0.5% potassium sorbate. In some embodiments, the composition may comprise 0.01-0.5% potassium sorbate. In some embodiments, the composition may comprise 0.05-0.4% potassium sorbate. In some embodiments, the composition may comprise 0.01-0.1% potassium sorbate. In some embodiments, the composition may comprise 0.1-0.2% potassium sorbate. In some embodiments, the composition may comprise 0.2-0.3% potassium sorbate. In some embodiments, the composition may comprise 0.3-0.4% potassium sorbate. In some embodiments, the composition may comprise 0.4-0.5% potassium sorbate.

The composition is a liquid and substantially comprises water. In some embodiments, the composition may comprise 70-95% water. In some embodiments, the composition may comprise 85-95% water. In some embodiments, the composition may comprise 70-75% water. In some embodiments, the composition may comprise 75-80% water. In some embodiments, the composition may comprise 80-85% water. In some embodiments, the composition may comprise 85-90% water. In some embodiments, the composition may comprise 90-95% water. The liquid nature and high water content of the composition facilitates administration of the composition in a variety of manners, such as but not limit to: flowing through an irrigation system, flowing through an above ground drip irrigation system, flowing through a buried drip irrigation system, flowing through a central pivot irrigation system, sprayers, sprinklers, and water cans.

The liquid composition may be used immediately after formulation, or may be stored in containers for later use. In some embodiments, the composition may be stored out of direct sunlight. In some embodiments, the composition may be refrigerated. In some embodiments, the composition may be stored at 1-10° C. In some embodiments, the composition may be stored at 1-3° C. In some embodiments, the composition may be stored at 3-5° C. In some embodiments, the composition may be stored at 5-8° C. In some embodiments, the composition may be stored at 8-10° C.

Administration of the liquid composition treatment to a Fabaceae seed or plant may be in an amount effective to produce an enhanced characteristic in plants compared to a substantially identical population of untreated seeds or plants. Such enhanced characteristics may comprise accelerated seed germination, accelerated seedling emergence, improved seedling emergence, improved leaf formation, accelerated leaf formation, improved plant maturation, and accelerated plant maturation. Non-limiting examples of such enhanced characteristics may comprise accelerated achievement of the hypocotyl stage, accelerated protrusion of a stem from the soil, accelerated achievement of the cotyledon stage, and accelerated leaf formation. Such enhanced characteristics may occur individually in a plant, or in combinations of multiple enhanced characteristics.

Surprisingly, the inventors found that administration of the described composition in low concentration applications was effective in producing enhanced characteristics in Fabaceae plants. In some embodiments, the liquid composition treatment is administered before the seed is planted. In some embodiments, the liquid composition treatment is administered at the time the seed is planted. In some embodiments, the liquid composition treatment is administered after the seed is planted.

In some embodiments, administration of the liquid composition may increase the number of plants emerged by 20-160% compared to a substantially identical population of untreated seeds or plants. In some embodiments, administration of the liquid composition may increase the number of plants emerged by at least 20% compared to a substantially identical population of untreated seeds or plants. In some embodiments, administration of the liquid composition may increase the number of plants emerged by at least 40% compared to a substantially identical population of untreated seeds or plants. In some embodiments, administration of the liquid composition may increase the number of plants emerged by at least 60% compared to a substantially identical population of untreated seeds or plants. In some embodiments, administration of the liquid composition may increase the number of plants emerged by at least 80% compared to a substantially identical population of untreated seeds or plants. In some embodiments, administration of the liquid composition may increase the number of plants emerged by at least 100% compared to a substantially identical population of untreated seeds or plants. In some embodiments, administration of the liquid composition may increase the number of plants emerged by at least 120% compared to a substantially identical population of untreated seeds or plants. In some embodiments, administration of the liquid composition may increase the number of plants emerged by at least 140% compared to a substantially identical population of untreated seeds or plants. In some embodiments, administration of the liquid composition may increase the number of plants emerged by at least 150% compared to a substantially identical population of untreated seeds or plants.

In some embodiments, administration of the liquid composition may increase the number plants demonstrating maturation by leaf formation by 30-180% compared to a substantially identical population of untreated seeds or plants. In some embodiments, administration of the liquid composition may increase the number plants demonstrating maturation by leaf formation by at least 30% compared to a substantially identical population of untreated seeds or plants. In some embodiments, administration of the liquid composition may increase the number plants demonstrating maturation by leaf formation by at least 50% compared to a substantially identical population of untreated seeds or plants. In some embodiments, administration of the liquid composition may increase the number plants demonstrating maturation by leaf formation by at least 70% compared to a substantially identical population of untreated seeds or plants. In some embodiments, administration of the liquid composition may increase the number plants demonstrating maturation by leaf formation by at least 90% compared to a substantially identical population of untreated seeds or plants. In some embodiments, administration of the liquid composition may increase the number plants demonstrating maturation by leaf formation by at least 110% compared to a substantially identical population of untreated seeds or plants. In some embodiments, administration of the liquid composition may increase the number plants demonstrating maturation by leaf formation by at least 130% compared to a substantially identical population of untreated seeds or plants. In some embodiments, administration of the liquid composition may increase the number plants demonstrating maturation by leaf formation by at least 150% compared to a substantially identical population of untreated seeds or plants. In some embodiments, administration of the liquid composition may increase the number plants demonstrating maturation by leaf formation by at least 160% compared to a substantially identical population of untreated seeds or plants. In some embodiments, administration of the liquid composition may increase the number plants demonstrating maturation by leaf formation by at least 170% compared to a substantially identical population of untreated seeds or plants.

### Seed Soak Application

In one non-limiting embodiment, the administration of the liquid composition treatment may comprise soaking the seed in an effective amount of the liquid composition before planting the seed. In some embodiments, the administration of the liquid composition further comprises removing the seed from the liquid composition after soaking, and drying the seed before planting. In some embodiments, the seed may be soaked in the liquid composition for a time period in the range of 90-150 minutes. In some embodiments, the seed may be soaked in the liquid composition for a time period in the range of 110-130 minutes. In some embodiments, the seed may be soaked in the liquid composition for a time period in the range of 90-100 minutes. In some embodiments, the seed may be soaked in the liquid composition for a time period in the range of 100-110 minutes. In some embodiments, the seed may be soaked in the liquid composition for a time period in the range of 110-120 minutes. In some embodiments, the seed may be soaked in the liquid composition for a time period in the range of 120-130 minutes. In some embodiments, the seed may be soaked in the liquid composition for a time period in the range of 130-140 minutes. In some embodiments, the seed may be soaked in the liquid composition for a time period in the range of 140-150 minutes.

The composition may be diluted to a lower concentration for an effective amount in a seed soak application by mixing a volume of the composition in a volume of water. The percent solids of mixotrophic Chlorella whole cells resulting in the diluted composition may be calculated by the multiplying the original percent solids in the composition by the ratio of the volume of the composition to the volume of water. In some embodiments, the effective amount in a seed soak application of the liquid composition may comprise a concentration in the range of 6-10 mL/gallon, resulting in a reduction of the percent solids of mixotrophic Chlorella whole cells from 5-30% to 0.007925-0.079252% (e.g., about 0.008% to about 0.080%). In some embodiments, the effective amount in a seed soak application of the liquid composition may comprise a concentration in the range of 7-9 mL/gallon, resulting in a reduction of the percent solids of mixotrophic Chlorella whole cells from 5-30% to 0.009245-0.071327% (e.g., about 0.009% to about 0.070%). In some embodiments, the effective amount in a seed soak application of the liquid composition may comprise a concentration in the range of 6-7 mL/gallon, resulting in a reduction of the percent solids of mixotrophic Chlorella whole cells from 5-30% to 0.007925-0.05547% (e.g., about 0.008% to about 0.055%). In some embodiments, the effective amount in a seed soak application of the liquid composition may comprise a concentration in the range of 7-8 mL/gallon, resulting in a reduction of the percent solids of mixotrophic Chlorella whole cells from 5-30% to 0.009246-0.063401% (e.g., about 0.009% to about 0.065%). In some embodiments, the effective amount in a seed soak application of the liquid composition may comprise a concentration in the range of 8-9 mL/gallon, resulting in a reduction of the percent solids of mixotrophic Chlorella whole cells from 5-30% to 0.010567-0.071327% (e.g., about 0.010% to about 0.070%). In some embodiments, the effective amount in a seed soak application of the liquid composition may comprise a concentration in the range of 9-10 mL/gallon, resulting in a reduction of the percent solids of mixotrophic Chlorella whole cells from 5-30% to 0.011888-0.079252% (e.g., about 0.012% to about 0.080%).

### Soil Application

In another non-limiting embodiment, the administration of the liquid composition treatment may comprise contacting the soil in the immediate vicinity of the planted seed with an effective amount of the liquid composition. In some embodiments, the liquid composition may be supplied to the soil by injection into a low volume irrigation system, such as but not limited to a drip irrigation system supplying water beneath the soil through perforated conduits or at the soil level by fluid conduits hanging above the ground or protruding from the ground. In some embodiments, the liquid composition may be supplied to the soil by a soil drench method wherein the liquid composition is poured on the soil.

The composition may be diluted to a lower concentration for an effective amount in a soil application by mixing a volume of the composition in a volume of water. The percent solids of mixotrophic Chlorella whole cells resulting in the diluted composition may be calculated by the multiplying the original percent solids in the composition by the ratio of the volume of the composition to the volume of water. In some embodiments, the effective amount in a soil application of the liquid composition may comprise a concentration in the range of 3.5-10 mL/gallon, resulting in a reduction of the percent solids of mixotrophic Chlorella whole cells from 5-30% to 0.004623-0.079252% (e.g., about 0.004% to about 0.080%). In some embodiments, the effective amount in a soil application of the liquid composition may comprise a concentration in the range of 3.5-4 mL/gallon, resulting in a reduction of the percent solids of mixotrophic Chlorella whole cells from 5-30% to 0.004623-0.031701% (e.g., about 0.004% to about 0.032%). In some embodiments, the effective amount in a soil application of the liquid composition may comprise a concentration in the range of 4-5 mL/gallon, resulting in a reduction of the percent solids of mixotrophic Chlorella whole cells from 5-30% to 0.005283-0.039626% (e.g., about 0.005% to about 0.040%). In some embodiments, the effective amount in a soil application of the liquid composition may comprise a concentration in the range of 5-6 mL/gallon, resulting in a reduction of the percent solids of mixotrophic Chlorella whole cells from 5-30% to 0.006604-0.047551% (e.g., about 0.006% to about 0.050%). In some embodiments, the effective amount in a soil application of the liquid composition may comprise a concentration in the range of 6-7 mL/gallon, resulting in a reduction of the percent solids of mixotrophic Chlorella whole cells from 5-30% to 0.0.007925-0.055476% (e.g., about 0.008% to about 0.055%). In some embodiments, the effective amount in a soil application of the liquid composition may comprise a concentration in the range of 7-8 mL/gallon, resulting in a reduction of the percent solids of mixotrophic Chlorella whole cells from 5-30% to 0.009246-0.063401% (e.g., about 0.009% to about 0.065%). In some embodiments, the effective amount in a soil application of the liquid composition may comprise a concentration in the range of 8-9 mL/gallon, resulting in a reduction of the percent solids of mixotrophic Chlorella whole cells from 5-30% to 0.010567-0.071327% (e.g., about 0.010% to about 0.075%). In some embodiments, the effective amount in a soil application of the liquid composition may comprise a concentration in the range of 9-10 mL/gallon, resulting in a reduction of the percent solids of mixotrophic Chlorella whole cells from 5-30% to 0.011888-0.079252% (e.g., about 0.012% to about 0.080%).

The rate of application of the composition at the desired concentration may be expressed as a volume per area. In some embodiments, the rate of application of the liquid composition in a soil application may comprise a rate in the range of 50-150 gallons/acre. In some embodiments, the rate of application of the liquid composition in a soil application may comprise a rate in the range of 75-125 gallons/acre. In some embodiments, the rate of application of the liquid composition in a soil application may comprise a rate in the range of 50-75 gallons/acre. In some embodiments, the rate of application of the liquid composition in a soil application may comprise a rate in the range of 75-100 gallons/acre. In some embodiments, the rate of application of the liquid composition in a soil application may comprise a rate in the range of 100-125 gallons/acre. In some embodiments, the rate of application of the liquid composition in a soil application may comprise a rate in the range of 125-150 gallons/acre.

### Capillary Action Application

In another non-limiting embodiment, the administration of the liquid composition treatment may comprise first soaking the seed in water, removing the seed from the water, drying the seed, applying an effective amount of the liquid composition below the seed planting level in the soil, and planting the seed, wherein the liquid composition supplied to the seed from below by capillary action. In some embodiments, the seed may be soaked in water for a time period in the range of 90-150 minutes. In some embodiments, the seed may be soaked in water for a time period in the range of 110-130 minutes. In some embodiments, the seed may be soaked in water for a time period in the range of 90-100 minutes. In some embodiments, the seed may be soaked in water for a time period in the range of 100-110 minutes. In some embodiments, the seed may be soaked in water for a time period in the range of 110-120 minutes. In some embodiments, the seed may be soaked in water for a time period in the range of 120-130 minutes. In some embodiments, the seed may be soaked in water for a time period in the range of 130-140 minutes. In some embodiments, the seed may be soaked in water for a time period in the range of 140-150 minutes.

The composition may be diluted to a lower concentration for an effective amount in a capillary action application by mixing a volume of the composition in a volume of water. The percent solids of mixotrophic Chlorella whole cells resulting in the diluted composition may be calculated by the multiplying the original percent solids in the composition by the ratio of the volume of the composition to the volume of water. In some embodiments, the effective amount in a capillary action application of the liquid composition may comprise a concentration in the range of 6-10 mL/gallon, resulting in a reduction of the percent solids of mixotrophic Chlorella whole cells from 5-30% to 0.007925-0.079252% (e.g., about 0.008% to about 0.080%). In some embodiments, the effective amount in a capillary action application of the liquid composition may comprise a concentration in the range of 7-9 mL/gallon, resulting in a reduction of the percent solids of mixotrophic Chlorella whole cells from 5-30% to 0.009245-0.071327% (e.g., about 0.009% to about 0.075%). In some embodiments, the effective amount in a capillary action application of the liquid composition may comprise a concentration in the range of 6-7 mL/gallon, resulting in a reduction of the percent solids of mixotrophic Chlorella whole cells from 5-30% to 0.007925-0.05547% (e.g., about 0.008% to about 0.055%). In some embodiments, the effective amount in a capillary action application of the liquid composition may comprise a concentration in the range of 7-8 mL/gallon, resulting in a reduction of the percent solids of mixotrophic Chlorella whole cells from 5-30% to 0.009246-0.063401% (e.g., about 0.009% to about 0.065%). In some embodiments, the effective amount in a capillary action application of the liquid composition may comprise a concentration in the range of 8-9 mL/gallon, resulting in a reduction of the percent solids of mixotrophic Chlorella whole cells from 5-30% to 0.010567-0.071327% (e.g., about 0.010% to about 0.075%). In some embodiments, the effective amount in a capillary action application of the liquid composition may comprise a concentration in the range of 9-10 mL/gallon, resulting in a reduction of the percent solids of mixotrophic Chlorella whole cells from 5-30% to 0.011888-0.079252% (e.g., about 0.012% to about 0.080%).

Whether in a seed soak, soil, or capillary action application the method of use comprises relatively low concentrations of the liquid composition. Even at such low concentrations, the described composition has been shown to be effective at producing an enhanced characteristic in Fabaceae plants. The ability to use low concentrations allows for a reduced impact on the environment that may result from over application and an increased efficiency in the method of use of the liquid composition by requiring a small amount of material to produce the desired effect. In some embodiments, the use of the liquid composition with a low volume irrigation system in soil applications allows the low concentration of the liquid composition to remain effective and not be diluted to a point where the composition is no longer in at a concentration capable of producing the desired effect on the plants while also increasing the grower's water use efficiency. The ability to use low concentrations of mixotrophic Chlorella whole cells and lack of purification processes to isolate the cells also reduces the dewatering and processing needs of the microalgae which may be produced at low concentrations in the culturing stage, and thus increasing the energy efficiency in the method of preparing the product. The use of mixotrophic Chlorella whole cells that have not been previously subjected to processing to dry, extract, lyse, or otherwise disrupt the cell wall also increases energy efficiency in the method of preparing the product and allows the product to be produced in a quicker time frame.

### EXAMPLES

Embodiments of the invention are exemplified and additional embodiments are disclosed in further detail in the following Examples, which are not in any way intended to limit the scope of any aspects of the invention described herein.

### Example 1

An experiment was conducted to determine if the method of application of a low concentration of a mixotrophic Chlorella based composition to green bean seeds (Phaseolus vulgaris) planted in soil affected the rate at which the seedlings emerge from the soil and mature. Green beans are part of the Fabaceae family. Green bean seeds were planted in trays with a potting soil mix of sphagnum moss, perlite, and vermiculite (2:1:1). Three treatments comprising a mixotrophic Chlorella based composition were compared to an untreated control (UTC). The treatments were pasteurized, normalized to 10% solids, and stabilized with phosphoric acid (H₃PO₄) and potassium sorbate (C₆H₇KO₂), with the remaining balance consisting of water. The stored mixotrophic Chlorella based composition was frozen after being harvested from the microalgae culturing system and thawed before formulation in the liquid composition for treatments used in the experiment. The fresh mixotrophic Chlorella based composition was not previously frozen, and was incorporated into the liquid composition for treatments used in this experiment directly after being harvested from the microalgae culturing system. The composition used in the treatments of this experiment were not analyzed to quantify bacteria in the compositions, however aerobic plate counts for previous compositions prepared with the same components in the same manner contained 40,000-400,000 CFU/mL.

The mixotrophic Chlorella based liquid composition treatments were applied to the seeds through two different treatment methods. The first treatment method comprised soaking the seeds in the low concentration of 8 mL/gallon of the mixotrophic Chlorella based liquid composition for two hours with constant sparging of air to avoid oxygen deprivation, removing the seeds from the composition, drying the seeds overnight, and then planting the seeds in the potting soil mix. The second treatment method comprised soaking the seeds in water for two hours with constant sparing of air to avoid oxygen deprivation, removing the seeds from water, drying the seeds overnight, planting the seeds in the potting soil mix with the low concentration of 8 mL/gallon of the mixotrophic Chlorella based liquid composition in the base of the planting tray to allow the seeds to be treated with the liquid composition through capillary action. The tested concentration of 8 mL/gallon diluted the composition which originally contained 10% solids by weight of mixotrophic Chlorella whole cells to the low percent solids content of only 0.021134%.

Each of the three treatments were applied to 72 seeds. Visual observations of the soil and plants were made daily to record how many seeds had achieved emergence and maturation, as explained below. The standard used for assessing emergence was the achievement of the hypocotyl stage, where a stem was visibly protruding from the potting soil mix. The standard used for assessing maturation was the achievement of the cotyledon stage, where two leaves had visibly formed on the emerged stem. The experiment was conducted indoors with all seeds and treatments subjected to the same controlled conditions including temperature, light, and supply of water. No other nutrients were supplied during the experiment. Light supplied was artificial and provided by fluorescent bulbs 24 hours a day. Results of the experiment are presented in Tables 1-6.

TABLE 1

| | Number of plants emerged by day | | | | | | | |
|---|---|---|---|---|---|---|---|---|
| | 1 | 2 | 3 | 4 | 5 | 6 | 7 | 8 |
| Untreated Control | 0 | 0 | 0 | 2 | 23 | 30 | 31 | 33 |
| (UTC) | | | | | | | | |
| 10% Mixotrophic | 0 | 0 | 0 | 10 | 36 | 41 | 43 | 45 |
| Chlorella Fresh Soak | | | | | | | | |
| 10% Mixotrophic | 0 | 0 | 0 | 3 | 33 | 40 | 42 | 42 |
| Chlorella Stored Soak | | | | | | | | |
| 10% Mixotrophic | 0 | 0 | 0 | 0 | 10 | 15 | 25 | 34 |
| Chlorella Fresh | | | | | | | | |
| Capillary | | | | | | | | |

TABLE 2

| | % of total plants emerged by day | | | | | | | |
|---|---|---|---|---|---|---|---|---|
| | 1 | 2 | 3 | 4 | 5 | 6 | 7 | 8 |
| Untreated Control | 0 | 0 | 0 | 3 | 32 | 42 | 43 | 46 |
| (UTC) | | | | | | | | |
| 10% Mixotrophic | 0 | 0 | 0 | 14 | 50 | 57 | 60 | 63 |
| Chlorella Fresh Soak | | | | | | | | |
| 10% Mixotrophic | 0 | 0 | 0 | 4 | 46 | 56 | 58 | 58 |
| Chlorella Stored Soak | | | | | | | | |
| 10% Mixotrophic | 0 | 0 | 0 | 0 | 14 | 21 | 35 | 47 |
| Chlorella Fresh | | | | | | | | |
| Capillary | | | | | | | | |

TABLE 3

| | % increase of plants emerged by | | | | | | | |
|---|---|---|---|---|---|---|---|---|
| | day over the UTC | | | | | | | |
| | 1 | 2 | 3 | 4 | 5 | 6 | 7 | 8 |
| 10% Mixotrophic | — | — | — | 400% | 57% | 37% | 39% | 36% |
| Chlorella Fresh | | | | | | | | |
| Soak | | | | | | | | |
| 10% Mixotrophic | — | — | — | 50% | 43% | 33% | 35% | 27% |
| Chlorella Stored | | | | | | | | |
| Soak | | | | | | | | |
| 10% Mixotrophic | — | — | — | −100% | −57% | −50% | −19% | 3% |
| Chlorella Fresh | | | | | | | | |
| Capillary | | | | | | | | |

As shown in the Tables 1-3, the seed soak treatment for the fresh and stored mixotrophic Chlorella based compositions showed consistently higher performance than the capillary action treatment and the UTC regarding emergence of the plants. The stored mixotrophic Chlorella based composition seed soak treatment showed at least a 27% and as much as a 50% increase over the UTC on comparative days, and the fresh mixotrophic Chlorella based composition seed soak treatment demonstrated at least a 36% and as much as a 400% increase over the UTC. The emergence for the fresh mixotrophic Chlorella based composition consistently outperformed the stored mixotrophic Chlorella based composition in the seed soak treatments, with the difference between the two treatments being the largest on day 4 and narrowing over the duration of the experiment. These results show that a low concentration of a mixotrophic Chlorella based composition is effective in increasing the emergence of a seedling as compared to an untreated seed when applied in a seed soak application.

TABLE 4

| | Number of plants matured by day | | | | | | | |
|---|---|---|---|---|---|---|---|---|
| | 1 | 2 | 3 | 4 | 5 | 6 | 7 | 8 |
| Untreated Control | 0 | 0 | 0 | 0 | 0 | 13 | 21 | 27 |
| (UTC) | | | | | | | | |
| 10% Mixotrophic | 0 | 0 | 0 | 0 | 0 | 25 | 32 | 37 |
| Chlorella Fresh Soak | | | | | | | | |
| 10% Mixotrophic | 0 | 0 | 0 | 0 | 0 | 13 | 30 | 35 |
| Chlorella Stored Soak | | | | | | | | |
| 10% Mixotrophic | 0 | 0 | 0 | 0 | 0 | 1 | 6 | 15 |
| Chlorella Fresh | | | | | | | | |
| Capillary | | | | | | | | |

TABLE 5

| | % of total plants matured by day | | | | | | | |
|---|---|---|---|---|---|---|---|---|
| | 1 | 2 | 3 | 4 | 5 | 6 | 7 | 8 |
| Untreated Control | 0 | 0 | 0 | 0 | 0 | 18 | 29 | 38 |
| (UTC) | | | | | | | | |
| 10% Mixotrophic | 0 | 0 | 0 | 0 | 0 | 35 | 44 | 51 |
| Chlorella Fresh Soak | | | | | | | | |
| 10% Mixotrophic | 0 | 0 | 0 | 0 | 0 | 18 | 42 | 49 |
| Chlorella Stored Soak | | | | | | | | |
| 10% Mixotrophic | 0 | 0 | 0 | 0 | 0 | 1 | 8 | 21 |
| Chlorella Fresh | | | | | | | | |
| Capillary | | | | | | | | |

TABLE 6

| | % increase of plants matured by | | | | | | | |
|---|---|---|---|---|---|---|---|---|
| | day over the UTC | | | | | | | |
| | 1 | 2 | 3 | 4 | 5 | 6 | 7 | 8 |
| 10% Mixotrophic | — | — | — | — | — | 92% | 52% | 37% |
| Chlorella Fresh Soak | | | | | | | | |
| 10% Mixotrophic | — | — | — | — | — | 0% | 43% | 30% |
| Chlorella Stored Soak | | | | | | | | |
| 10% Mixotrophic | — | — | — | — | — | −92% | −71% | −44% |
| Chlorella Fresh | | | | | | | | |
| Capillary | | | | | | | | |

As shown in the Tables 4-6, the seed soak treatment for the fresh and stored mixotrophic Chlorella based compositions showed consistently higher performance than the capillary action treatment and the UTC regarding maturation of the plants. The stored mixotrophic Chlorella based composition seed soak treatment showed at least a 30% and as much as a 43% increase over the untreated control on comparative days, and the fresh mixotrophic Chlorella based composition seed soak treatment demonstrated at least a 37% and as much as a 92% increase over the UTC. The maturation for the fresh mixotrophic Chlorella composition consistently outperformed the stored mixotrophic Chlorella based composition in the seed soak treatments, with the difference between the two treatments being the largest on day 6 and narrowing over the duration of the experiment. The capillary action treatment was consistently outperformed by the UTC regarding maturation of the plants. These results show that a low concentration of a mixotrophic Chlorella based composition is effective in increasing the maturation of a seedling as compared to an untreated seed when applied in a seed soak application.

### Example 2

An experiment was conducted to determine if the method of application of a low concentration a mixotrophic Chlorella based composition to green bean seeds (Phaseolus vulgaris) planted in soil affected the rate at which the seedlings emerge from the soil and mature. Green bean seeds were planted in trays with a potting soil mix of sphagnum moss, perlite, and vermiculite (2:1:1). Two treatments comprising a mixotrophic Chlorella based composition were compared to an untreated control (UTC). The treatments were pasteurized, normalized to 10% solids, and stabilized with phosphoric acid (H₃PO₄) and potassium sorbate (C₆H₇KO₂), with the remaining balance consisting of water. The mixotrophic Chlorella based composition was not previously frozen, and was incorporated into the liquid composition for treatments used in this experiment directly after being harvested from the microalgae culturing system. The composition used in the treatments of this experiment was not analyzed to quantify bacteria in the composition, however aerobic plate counts for previous compositions prepared with the same components in the same manner contained 40,000-400,000 CFU/mL.

The mixotrophic Chlorella based liquid composition treatments were applied to the seeds at two different low concentrations, 4.7 mL/gallon or 8 mL/gallon, using the same treatment method. The tested concentration of 4.7 mL/gallon diluted the composition which originally contained 10% solids by weight of mixotrophic Chlorella whole cells to the low percent solids content of only 0.012416%. The tested concentration of 8 mL/gallon diluted the composition which originally contained 10% solids by weight of mixotrophic Chlorella whole cells to the low percent solids content of only 0.021134%. The treatment method consisted of drenching the soil from the top with 0.75 gallon of the liquid composition (equivalent to an application rate of 100 gallons/acre) at the identified concentrations after planting the seeds.

Each of the two treatments were applied to two trays of 72 seeds. Visual observations of the soil and plants were made daily to record how many seeds had achieved emergence and maturation, as explained below. The standard used for assessing emergence was the achievement of the hypocotyl stage where a stem was visibly protruding from the potting soil mix. The standard used for assessing maturation was the achievement of the cotyledon stage where two leaves had visibly formed on the emerged stem. The experiment was conducted indoors with all seeds and treatments subjected to the same controlled conditions including temperature, light, and supply of water. No other nutrients were supplied during the experiment. Light supplied was artificial and provided by fluorescent bulbs 24 hours a day. Results of the experiment are presented in Tables 7-12.

TABLE 7

| | Number of plants emerged by day | | | | | | | | |
|---|---|---|---|---|---|---|---|---|---|
| | 1 | 2 | 3 | 4 | 5 | 6 | 7 | 8 | 9 |
| Untreated Control | — | — | 9 | 22 | 32 | 36 | 42 | 46 | 47 |
| (UTC) | | | | | | | | | |
| 10% Mixotrophic | — | — | 11 | 29 | 51 | 58 | 62 | 63 | 64 |
| Chlorella 4.7 mL | | | | | | | | | |
| 10% Mixotrophic | — | — | 13 | 43 | 77 | 91 | 104 | 107 | 110 |
| Chlorella 8 mL | | | | | | | | | |

TABLE 8

| | % of total plants emerged by day | | | | | | | | |
|---|---|---|---|---|---|---|---|---|---|
| | 1 | 2 | 3 | 4 | 5 | 6 | 7 | 8 | 9 |
| Untreated Control | 0 | 0 | 6 | 15 | 22 | 25 | 29 | 32 | 33 |
| (UTC) | | | | | | | | | |
| 10% Mixotrophic | 0 | 0 | 8 | 20 | 35 | 40 | 43 | 44 | 44 |
| Chlorella 4.7 mL | | | | | | | | | |
| 10% Mixotrophic | 0 | 0 | 9 | 30 | 53 | 63 | 72 | 74 | 76 |
| Chlorella 8 mL | | | | | | | | | |

TABLE 9

| | % increase of plants emerged by day over the UTC | | | | | | | | |
|---|---|---|---|---|---|---|---|---|---|
| | 1 | 2 | 3 | 4 | 5 | 6 | 7 | 8 | 9 |
| 10% | — | — | 22% | 32% | 59% | 61% | 48% | 37% | 36% |
| Mixotrophic | | | | | | | | | |
| Chlorella | | | | | | | | | |
| 4.7 mL | | | | | | | | | |
| 10% | — | — | 44% | 95% | 141% | 153% | 148% | 133% | 134% |
| Mixotrophic | | | | | | | | | |
| Chlorella | | | | | | | | | |
| 8 mL | | | | | | | | | |

As shown in the Tables 7-9, the 8 and 4.7 mL/gallon applications showed consistently higher performance than the UTC regarding emergence of the plants, with the 8 mL/gallon application consistently performing better than the 4.7 mL/gallon. The 4.7 mL/gallon application showed at least a 22% and as much as a 61% increase over the UTC on comparative days, and the 8 mL/gallon application demonstrated at least a 44% and as much as a 153% increase over the UTC. These results show that a low concentration of a mixotrophic Chlorella based composition is effective in increasing the emergence of a seedling as compared to an untreated seed when applied in a soil drench application.

TABLE 10

| | Number of plants matured by day | | | | | | | | |
|---|---|---|---|---|---|---|---|---|---|
| | 1 | 2 | 3 | 4 | 5 | 6 | 7 | 8 | 9 |
| Untreated Control | — | — | 0 | 0 | 2 | 14 | 26 | 31 | 34 |
| (UTC) | | | | | | | | | |
| 10% Mixotrophic | — | — | 0 | 0 | 2 | 26 | 52 | 57 | 58 |
| Chlorella 4.7 mL | | | | | | | | | |
| 10% Mixotrophic | — | — | 0 | 0 | 0 | 29 | 60 | 76 | 94 |
| Chlorella 8 mL | | | | | | | | | |

TABLE 11

| | % of total plants matured by day | | | | | | | | |
|---|---|---|---|---|---|---|---|---|---|
| | 1 | 2 | 3 | 4 | 5 | 6 | 7 | 8 | 9 |
| Untreated Control | 0 | 0 | 0 | 0 | 1 | 10 | 18 | 22 | 24 |
| (UTC) | | | | | | | | | |
| 10% Mixotrophic | 0 | 0 | 0 | 0 | 1 | 18 | 36 | 40 | 40 |
| Chlorella 4.7 mL | | | | | | | | | |
| 10% Mixotrophic | 0 | 0 | 0 | 0 | 0 | 20 | 42 | 53 | 65 |
| Chlorella 8 mL | | | | | | | | | |

TABLE 12

| | % increase of plants matured by day over the UTC | | | | | | | | |
|---|---|---|---|---|---|---|---|---|---|
| | 1 | 2 | 3 | 4 | 5 | 6 | 7 | 8 | 9 |
| 10% | — | — | — | — | 0% | 86% | 100% | 84% | 71% |
| Mixotrophic | | | | | | | | | |
| Chlorella | | | | | | | | | |
| 4.7 mL | | | | | | | | | |
| 10% | — | — | — | — | −100% | 107% | 131% | 145% | 176% |
| Mixotrophic | | | | | | | | | |
| Chlorella | | | | | | | | | |
| 8 mL | | | | | | | | | |

As shown in the Tables 10-12, the 8 and 4.7 mL/gallon applications showed consistently higher performance than the UTC regarding maturation of the plants, with the 8 mL/gallon application consistently performing better than the 4.7 mL/gallon. Starting on day 6, the 4.7 mL/gallon application showed at least a 71% and as much as a 100% increase over the UTC on comparative days and the 8 mL/gallon application demonstrated at least a 107% and as much as a 176% increase over the UTC. The increase in maturation performance for the 8 mL/gallon application over the UTC also increased over time. These results show that a low concentration of a mixotrophic Chlorella based composition is effective in increasing the maturation of a seedling as compared to an untreated seed when applied in a soil drench application.

With the characteristics that are shared among plants within the Fabaceae plant family, the results shown in the Examples are likely representative as to the effectiveness of mixotrophic Chlorella based composition as described throughout the specification on all plants in the Fabaceae plant family.

### Aspects of the Invention

In one non-limiting embodiment, a method for enhancing emergence of a Fabaceae plant from seed may comprise: administering a liquid composition treatment comprising a Chlorella culture in which the microalgae cell content of the culture consists essentially of whole pasteurized Chlorella cells in a concentration in the range of 0.003-0.080% solids by weight to a planted seed of a Fabaceae plant in an amount effective to enhance emergence of seeds, maturation, or both in a population of such seeds compared to seeds in a substantially identical population of untreated seeds.

In some embodiments, the administration may comprise soaking the seed in an effective amount of the liquid composition before planting the seed. In some embodiments, the seed may be soaked for a time period in the range of 90-150 minutes. In some embodiments, the liquid composition may comprise a concentration in the range of 0.008-0.080% solids by weight of whole pasteurized Chlorella cells. In some embodiments, the method may further comprise removing the seed from the liquid composition and drying the seed before planting the seed.

In some embodiments, the administration may comprise contacting the soil in the immediate vicinity of the planted seed with an effective amount of the liquid composition. In some embodiments, the liquid composition may comprise a concentration in the range of 0.004-0.080% solids by weight of whole pasteurized Chlorella cells. In some embodiments, the liquid composition may be administered at a rate in the range of 50-150 gallons per acre.

In some embodiments, the Fabaceae plant may comprise a green bean plant. In some embodiments, the liquid composition may further comprise a stabilizing means suitable for plants. In some embodiments, the whole Chlorella cells may not be subjected to a drying process. In some embodiments, the Chlorella cells may be cultured in mixotrophic conditions. In some embodiments, the Chlorella cells may be cultured in non-axenic mixotrophic conditions. In some embodiments, the liquid composition may not contain an active ingredient for enhancing emergence or maturation other than the culture of whole Chlorella cells.

In some embodiments, the number of plants emerged from the soil may be increased by at least 20% compared to a substantially identical population of untreated seeds of plants. In some embodiments, the number of plants demonstrating maturation by leaf formation may be increased by at least 30% compared to a substantially identical population of untreated seeds of plants.

In some embodiments, the administration may comprise: soaking the seed in water and drying the seed; and applying an effective amount of the liquid composition below a seed planting level in soil. In some embodiments, the seed may be soaked in water for a time period in the range of 90-150 minutes. In some embodiments, the liquid composition may comprise a concentration in the range of 0.008-0.080% solids by weight of whole pasteurized Chlorella cells.

In another non-limiting embodiment, a method of enhancing emergence of a Fabaceae plant from seed may comprise: providing a liquid composition treatment comprising a Chlorella culture in which the microalgae cell content of the culture consists essentially of whole pasteurized Chlorella cells in a concentration in the range of 5-30% solids by weight; diluting the liquid composition with water to a concentration in the range of 0.003-0.080% solids by weight of whole pasteurized Chlorella cells; and administering the liquid composition treatment to a planted seed of a Fabaceae plant in an amount effective to enhance emergence of seeds, maturation, or both in a population of such seeds compared to seeds in a substantially identical population of untreated seeds.

All references, including publications, patent applications, and patents, cited herein are hereby incorporated by reference in their entirety and to the same extent as if each reference were individually and specifically indicated to be incorporated by reference and were set forth in its entirety herein (to the maximum extent permitted by law), regardless of any separately provided incorporation of particular documents made elsewhere herein.

The use of the terms “a” and “an” and “the” and similar referents in the context of describing the invention are to be construed to cover both the singular and the plural, unless otherwise indicated herein or clearly contradicted by context.

Unless otherwise stated, all exact values provided herein are representative of corresponding approximate values (e.g., all exact exemplary values provided with respect to a particular factor or measurement can be considered to also provide a corresponding approximate measurement, modified by “about,” where appropriate). All provided ranges of values are intended to include the end points of the ranges, as well as values between the end points.

The description herein of any aspect or embodiment of the invention using terms such as “comprising”, “having,” “including,” or “containing” with reference to an element or elements is intended to provide support for a similar aspect or embodiment of the invention that “consists of”, “consists essentially of”, or “substantially comprises” that particular element or elements, unless otherwise stated or clearly contradicted by context (e.g., a composition described herein as comprising a particular element should be understood as also describing a composition consisting of that element, unless otherwise stated or clearly contradicted by context).

All headings and sub-headings are used herein for convenience only and should not be construed as limiting the invention in any way.

The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

The citation and incorporation of patent documents herein is done for convenience only and does not reflect any view of the validity, patentability, and/or enforceability of such patent documents.

This invention includes all modifications and equivalents of the subject matter recited in the claims and/or aspects appended hereto as permitted by applicable law.

1. A method for enhancing emergence of a Fabaceae plant from a seed, the method comprising: administering a liquid composition treatment comprising a Chlorella culture in which the microalgae cell content of the culture consists essentially of whole pasteurized Chlorella cells in a concentration in the range of 0.003-0.080% solids by weight to a planted seed of a Fabaceae plant in an amount effective to enhance emergence of seeds, maturation, or both in a population of such seeds compared to seeds in a substantially identical population of untreated seeds.

2. The method of claim 1, wherein the administration comprises soaking the seed in an effective amount of the liquid composition treatment before planting the seed.

3. The method of claim 2, wherein the seed is soaked for a time period in the range of 90-150 minutes.

4. The method of claim 2, wherein the liquid composition treatment comprises a concentration in the range of 0.008-0.080% solids by weight of whole pasteurized Chlorella cells.

5. The method of claim 2, the method further comprising removing the seed from the liquid composition treatment and drying the seed before planting the seed.

6. The method of claim 1, wherein the administration comprises contracting the soil in the immediate vicinity of the planted seed with an effective amount of the liquid composition treatment.

7. The method of claim 6, wherein the liquid composition treatment comprises a concentration in the range of 0.004-0.080% solids by weight of whole pasteurized Chlorella cells.

8. The method of claim 7, wherein the liquid composition treatment is administered at a rate in the range of 50-150 gallons per acre.

9. The method of claim 1, wherein the Fabaceae plant comprises a green bean plant.

10. The method of claim 1, wherein the liquid composition treatment further comprises stabilizing means suitable for plants.

11. The method of claim 1, wherein the whole Chlorella cells have not been subjected to a drying process.

12. The method of claim 1, wherein the Chlorella cells are cultured in mixotrophic conditions.

13. The method of claim 12, wherein the Chlorella cells are cultured in non-axenic mixotrophic conditions.

14. The method of claim 1, wherein the liquid composition treatment does not contain an active ingredient for enhancing emergence or maturation other than the culture of whole Chlorella cells.

15. The method of claim 1, wherein the number of plants emerged from the soil is increased by at least 20% compared to a substantially identical population of untreated seeds of plants.

16. The method of claim 1, wherein the number of plants demonstrating maturation by leaf formation is increased by at least 30% compared to a substantially identical population of untreated seeds of plants.

17. A method of enhancing emergence of a Fabaceae plant from a seed, the method comprising:
a. Providing a liquid composition treatment comprising a Chlorella culture in which the microalgae cell content of the culture consists essentially of whole pasteurized Chlorella cells in a concentration in the range of 5-30% solids by weight;
b. Diluting the liquid composition treatment with water to a concentration in the range of 0.003-0.080% solids by weight of whole pasteurized Chlorella cells; and
c. Administering the liquid composition treatment to a planted seed of a Fabaceae plant in an amount effective to enhance emergence of seeds, maturation, or both in a population of such seeds compared to seeds in a substantially identical population of untreated seeds.

18. The method of claim 17, wherein the administration comprises soaking the seed in an effective amount of the liquid composition treatment before planting the seed.

19. The method of claim 18, wherein the seed is soaked for a time period in the range of 90-150 minutes.

20. The method of claim 18, wherein the liquid composition treatment comprises a concentration in the range of 0.008-0.0802% solids by weight of whole pasteurized Chlorella cells.

21. The method of claim 18, the method further comprising removing the seed from the liquid composition treatment and drying the seed before planting the seed.

22. The method of claim 17, wherein the administration comprises contacting the soil in the immediate vicinity of the planted seed with an effective amount of the liquid composition treatment.

23. The method of claim 22, wherein the liquid composition treatment comprises a concentration in the range of 0.004-0.080% solids by weight of whole pasteurized Chlorella cells.

24. The method of claim 23, wherein the liquid composition treatment is administered at a rate in the range of 50-150 gallons per acre.

25. The method of claim 17, wherein the Fabaceae plant comprises a green bean plant.

26. The method of claim 17, wherein the liquid composition treatment further comprises stabilizing means suitable for plants.

27. The method of claim 17, wherein the whole Chlorella cells have not been subjected to a drying process.

28. The method of claim 17, wherein the Chlorella cells are cultured in mixotrophic conditions.

29. The method of claim 28, wherein the Chlorella cells are cultured in non-axenic mixotrophic conditions.

30. The method of claim 17, wherein the liquid composition treatment does not contain an active ingredient for enhancing emergence or maturation other than the culture of whole Chlorella cells.
